(19) United States
(12) Patent Application Publication
(10) Pub. No.: US 2014/0104813 A1
(43) Pub. Date: Apr. 17, 2014

(54) METHOD AND DEVICE FOR EMITTING AN ILLUMINATED LIQUID STREAM

(71) Applicant: Glo Tech, Inc., Leominster, MA (US)

(72) Inventor: Kevin G. Donahue, Harvard, MA (US)

(21) Appl. No.: 14/054,537

(22) Filed: Oct. 15, 2013

Related U.S. Application Data
(60) Provisional application No. 61/713,161, filed on Oct. 12, 2012.

(51) Int. Cl. F21V 33/00

(52) U.S. Cl. CPC F21V 33/00
USPC 362/96

(57) ABSTRACT

Method and device for emitting an illuminated water stream. According to one embodiment, the device includes a liquid stream generator for emitting at least one continuous liquid stream and an illumination device for emitting light. The liquid stream generator and the illumination device are arranged relative to one another so that light emitted from the illumination device is directed into at least one of the at least one continuous liquid stream at an angle such that at least one of the at least one continuous liquid stream is illuminated under the principle of total internal reflection. The liquid used to make the at least one continuous liquid stream may include water and at least one additive, such as a viscosity thickener and a light-diffusing agent.

### BACKGROUND OF THE INVENTION

The present invention relates generally to methods and devices for emitting liquid streams and relates more particularly to a novel method and device for emitting a liquid stream.

Squirt guns, water cannons, and other devices that emit a stream of water for amusement or other purposes have existed for decades. Such water-emitting devices typically operate by forcing water through a small orifice using pressure generated by a plunger or the like.

When water-emitting devices of the type described above are used under conditions of abundant ambient light, such as is typically the case when such devices are used outdoors in daylight, the water streams emitted from such devices are relatively easy to observe. By contrast, when such devices are used under conditions of poor ambient light, such as is typically the case when such devices are used outdoors at night, the water streams emitted from such devices are very difficult to observe.

In U.S. Pat. No. 4,239,129, inventor Esposito, which issued Dec. 16, 1980, and which is incorporated herein by reference, there is disclosed a toy water pistol and/or flashlight structure. More specifically, the aforementioned water pistol and/or flashlight structure includes a reciprocal pump for building up pressure against a liquid for ejecting a stream thereof forwardly through a nozzle an appreciable distance, valve means for controlling the flow of the liquid, a source of electricity, light responsive means and lamps for constituting means for illuminating the stream, a buzzer and a switch for controlling the operation of the lamp and buzzer, and a trigger for simultaneously operating the valve means and switch. A pump in the form of a piston, a piston rod, and rear handle is used to build air pressure within the reservoir or chamber. The air pressure from reciprocation of the piston within its cylinder forces air past a check valve and into the reservoir. The pressurized water is discharged from the reservoir through an outlet hose and it flows to a valve means. When the trigger is depressed to open the valve means against the biasing force of a spring, the pressurized water flows through an outlet hose to the nozzle at the front end of the gun. A lamp within a reflector is positioned immediately behind the nozzle to illuminate the stream of water.

In U.S. Pat. No. 6,474,507, inventors Hornsby et al., which issued Nov. 5, 2002, and which is incorporated herein by reference, there is disclosed a water gun amusement device. According to one embodiment, the device, which is adapted for shooting a stream or burst of liquid, comprises a generally elongated housing having a front end, a rear end, an internal chamber for containing a liquid and a portion for containing a source of electricity, a conduit connected to the chamber and to a nozzle at the front end, a pump for pressurizing the chamber for forcing a stream of liquid through the conduit and out of the nozzle, valve structures suitable for controlling the flow of liquid, including for making the stream of light coherent, at least one light source adjacent to the front end for illuminating a stream of liquid, means for coupling and operating the means for illuminating and the source of electricity, and a trigger mechanism connected to the housing for actuating a stream of liquid.

### SUMMARY OF THE INVENTION

It is an object of the present invention to provide a novel method and device for emitting an illuminated liquid stream.

Therefore, according to one aspect of the invention, there is provided a novel device for emitting an illuminated liquid stream, wherein the device may comprise (a) a liquid stream generator for emitting at least one continuous liquid stream; and (b) an illumination device for emitting light; (c) wherein the liquid stream generator and the illumination device are arranged relative to one another so that light emitted from the illumination device is directed into at least one of the at least one continuous liquid stream at an angle such that at least one of the at least one continuous liquid stream is illuminated under the principle of total internal reflection.

According to another aspect of the invention, the liquid stream generator may comprise a barrel, and the illumination device may be arranged relative to the liquid stream generator so that illumination of at least one of the at least one continuous liquid stream takes place within the barrel.

According to another aspect of the invention, the liquid stream generator may further comprise a fluid conduit, and the illumination device may be arranged relative to the liquid stream generator so that illumination of at least one of the at least one continuous liquid stream takes place after the at least one continuous liquid stream emerges from the fluid conduit.

According to another aspect of the invention, the liquid stream generator may emit a single continuous liquid stream.

According to another aspect of the invention, the liquid stream generator may emit a plurality of continuous liquid streams.

According to another aspect of the invention, the light emitted from the illumination device may be pulsed light.

According to another aspect of the invention, the light emitted from the illumination device may be a continuous beam of light.

According to another aspect of the invention, the illumination device may comprise at least one LED.

According to another aspect of the invention, the illumination device may comprise at least one laser diode.

According to another aspect of the invention, the liquid stream generator may be capable of emitting at least one continuous liquid stream having a horizontal length of about 15-30 feet.

According to another aspect of the invention, the liquid stream generator may be a portable water projecting device.

According to another aspect of the invention, the above-described device may be combined with a liquid supply used to make the at least one continuous liquid stream.

According to another aspect of the invention, the liquid supply may comprise water.

According to another aspect of the invention, the liquid supply may further comprise a viscosity thickener.

According to another aspect of the invention, the liquid supply may further comprise a light-diffusing agent.

According to another aspect of the invention, the liquid supply may further comprise a viscosity thickener and a light-diffusing agent.

According to another aspect of the invention, there is provided a method of generating an illuminated liquid stream, wherein said method may comprise the steps of (a) generating a continuous liquid stream using a portable water projecting device; and (b) illuminating the continuous liquid stream at an angle such that the continuous liquid stream is illuminated under the principle of total internal reflection.

According to another aspect of the invention, the continuous liquid stream of the aforementioned method may comprise water.

According to another aspect of the invention, the continuous liquid stream of the aforementioned method may further comprise at least one of a viscosity thickener and a light-diffusing agent.

For purposes of the present specification and claims, various relational terms like “top,” “bottom,” “proximal,” “distal,” “upper,” “lower,” “front,” and “rear” are used to describe the present invention when said invention is positioned in or viewed from a given orientation. It is to be understood that, by altering the orientation of the invention, certain relational terms may need to be adjusted accordingly. For example, unless provided otherwise, when used in the context of a device for emitting an illuminating liquid stream, the terms “proximal” and “distal” are relative terms, with the term “proximal” referring to a relative position “near” to the user of the device and the term “distal” referring to a relative position “far” from the user of the device.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a left side view of a first embodiment of a device for emitting an illuminated liquid stream;

FIG. 2 is a partly exploded side view of the device shown in FIG. 1;

FIG. 3 is a right side view, broken away in part, of the device shown in FIG. 1;

FIG. 4 is an enlarged right side view, partly in section and with one of the support members removed, of the distal end of the device shown in FIG. 1, certain components not being shown for clarity;

FIG. 5 is a longitudinal section view of the annular end-cap shown in FIG. 2;

FIG. 6 is a top view of the nozzle assembly shown in FIG. 3;

FIG. 7 is a distal end view of the nozzle assembly shown in FIG. 3;

FIG. 8 is a right side view of the left support member shown in FIG. 6;

FIG. 9 is a left side view of the right support member shown in FIG. 6;

FIG. 10 is a schematic side view, partly in section, of the distal end of the device shown in FIG. 1, illustrating how the device of FIG. 1 may be used to illuminate a water stream using the principle of total internal reflection; and

FIG. 11 is a distal end view of a first alternate nozzle assembly to that shown in FIG. 7.

### DETAILED DESCRIPTION OF THE INVENTION

The present invention is directed at a method and device for emitting an illuminated liquid stream. According to one embodiment of the present invention, a liquid stream is generated by conventional or other means, and light is injected into the liquid stream, either after the liquid stream has been emitted from a fluid conduit or while the liquid stream is flowing through a fluid conduit, the light being injected into the liquid stream in such a manner that the liquid stream becomes illuminated under the principle of total internal reflection. Under the principle of total internal reflection, if light enters a first medium, such as a water stream, that is surrounded by a second medium that has a lower index of refraction, such as air, and if this light enters the first medium at an angle lower than the critical angle of reflection (adjusted for refraction), the light entering the first medium remains trapped within the first medium due to its internal reflection by the first medium-second medium interface.

As can readily be appreciated, for the liquid stream to capture and to maintain its illumination, the liquid stream should possess a geometry that promotes total internal reflection of the injected light. The optimal shape to effect such light propagation is a cylinder. Thus, according to a preferred embodiment, the liquid stream is preferably in the form of an elongated cylindrical column.

In order to achieve a liquid stream in the desired shape of a cylindrical column, non-turbulent or laminar flow of the liquid stream is preferred. One way of achieving such flow is to force the liquid through one or more narrow flow tubes prior to introducing the liquid into one or more narrow dispensing tubes. Therefore, according to one embodiment of the invention, a single flow tube or an array of parallel flow tubes is used to generate a non-turbulent liquid stream that is then fed into one or more narrow dispensing tubes. Liquid enters such one or more flow tubes via the application of pressure to liquid that is housed in a reservoir that is fluidly coupled to the one or more flow tubes. Such an application of pressure can be achieved, for example, using a plunger to compress the liquid within the reservoir.

In accordance with the teachings of the present invention, the liquid that is used to form the liquid stream may be, for example, water or may be, for example, a homogeneous or heterogeneous mixture of water and one or more additives that may promote the generation of a long liquid stream capable of being easily illuminated by total internal reflection. Such additives may include, for example, one or more thickeners for increasing the viscosity of the liquid to promote the generation of a continuous stream. Such thickeners may include, for example, natural and non-toxic thickeners, such as food additives like agar-agar, methyl cellulose, and silica. More specifically, the thickener may be added in such an amount to increase the viscosity of the liquid to about 1 cps to 10 cps. An example of a particularly suitable thickener may be PolyOx water soluble polyethylene oxide resin (Dow Chemical Company, Midland, Mich.), which may be present in an amount constituting about 0.05% by weight of the mixture (e.g., about 1.8 g per gallon).

Such additives may also include, for example, a light-diffusing agent, such as titanium dioxide. For illustrative purposes, titanium dioxide may be present in the mixture in an amount up to about 5% by weight of the mixture and preferably in an amount constituting about 0.5% to about 1% by weight of the mixture (e.g., about 18-36 grams per gallon). To prevent an inhalation hazard, it may be desirable to encapsulate the titanium dioxide into a water soluble tablet, which is then added to the liquid.

The present invention is particularly well-suited for use under conditions of low ambient light, such as may be the case during outdoor nighttime use.

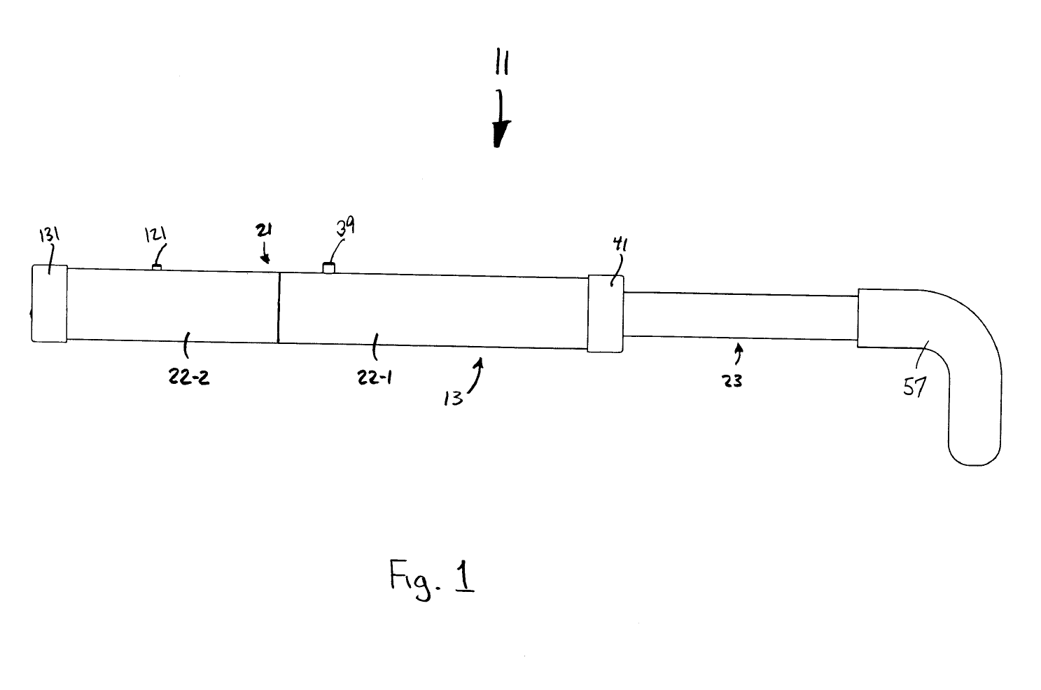

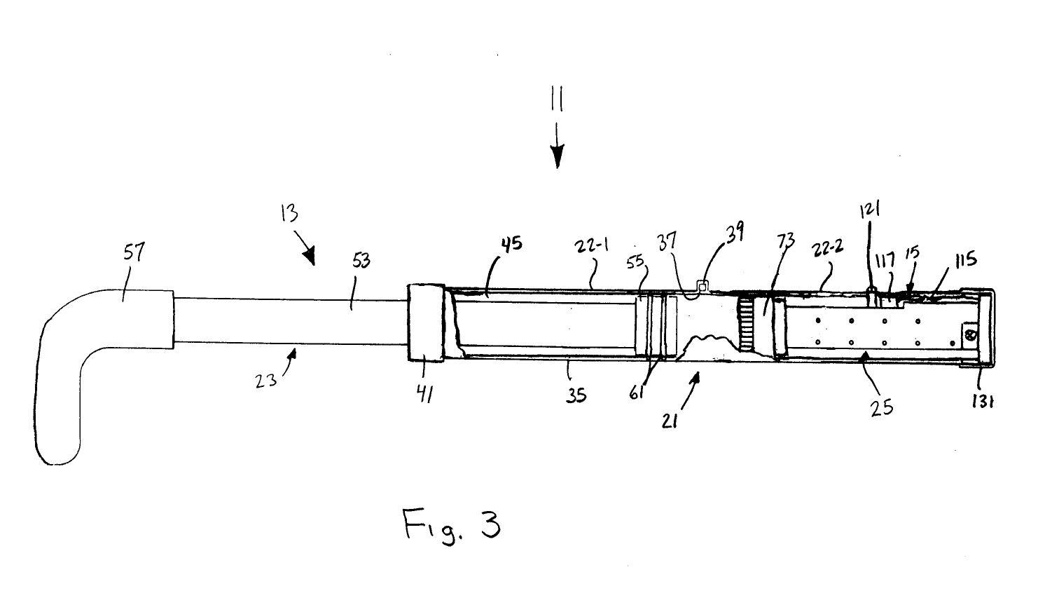

Referring now to FIGS. 1 through 4, there are shown various views of a first embodiment of a device for emitting an illuminated liquid stream, the device being represented generally by reference numeral 11.

Device 11 may comprise a liquid stream generator 13 and an illumination device 15. Liquid stream generator 13 and illumination device 15 may be arranged relative to one another so that light emitted from illumination device 15 may be directed into a liquid stream emitted by liquid stream generator 13 at such an angle that the liquid stream becomes illuminated under the principle of total internal reflection.

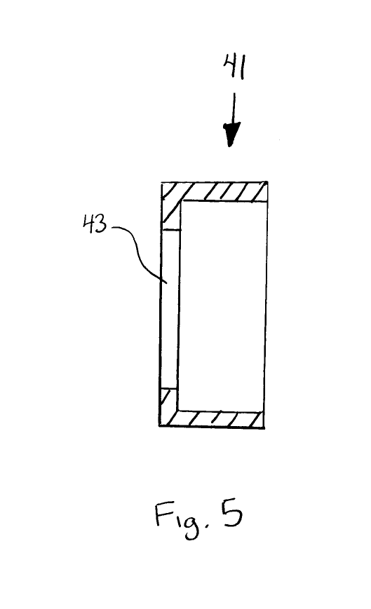

In the present embodiment, liquid stream generator 13 may comprise a barrel 21, a plunger 23, and a nozzle assembly 25. Barrel 21, in turn, may comprise a first barrel portion 22-1 and a second barrel portion 22-2, each of which may be made of a suitably strong molded polymer. First barrel portion 22-1 and second barrel portion 22-2 may be fixedly secured to one another by any suitable means, such as mating threads, one or more adhesives, and/or mechanical fasteners, such as screws. First barrel portion 22-1 may comprise a length of tubing having a proximal end 31, a distal end 33, and a circular side wall 35. As will become apparent from the discussion below, first barrel portion 22-1 may define a reservoir for the liquid to be emitted from device 11. As such, an opening 37, which may be fitted with a removable plug or one-way valve 39, may be provided in circular side wall 35 to enable liquid to enter into the interior of first barrel portion 22-1. An annular end-cap 41, which may be made of a suitably strong molded polymer, may be mounted over proximal end 31 of first barrel portion 22-1. Annular end-cap 41, which is also shown separately in FIG. 5, may have a proximal opening 43 (see FIG. 5) of reduced diameter as compared to the inner diameter of barrel 22-1.

Plunger 23, which may be made of a suitably strong molded polymer, may comprise an elongated tubular member having a proximal end 51, a circular side wall 53, and a distal end 55. Proximal end 51 of plunger 23 may be fixedly coupled to a handle 57. Circular side wall 53 of plunger 23 may be appropriately dimensioned relative to opening 43 of annular end-cap 41 so that plunger 23 may be proximally and distally moved in a sliding manner coaxially through end-cap 41 and into first barrel portion 22-1. Distal end 55 of plunger 23 may have an appropriately enlarged diameter relative to circular side wall 53 so as to prevent the withdrawal of distal end 55 of plunger 23 through opening 43 of annular end-cap 41. A plug (not shown) may be fixedly mounted in distal end 55 of plunger 23 to prevent fluid from entering plunger 23. One or more O-rings 61 may be fixedly mounted around the circumference of distal end 55 of plunger 23 and may be used to create a fluid-tight seal with the inner surface of circular side wall 35 of first barrel portion 22-1. In this manner, as plunger 23 may be moved distally relative to first barrel portion 22-1, any fluid disposed within first barrel portion 22-1 that may be located distal to plunger 23 may be forced distally through distal end 33 of first barrel portion 22-1.

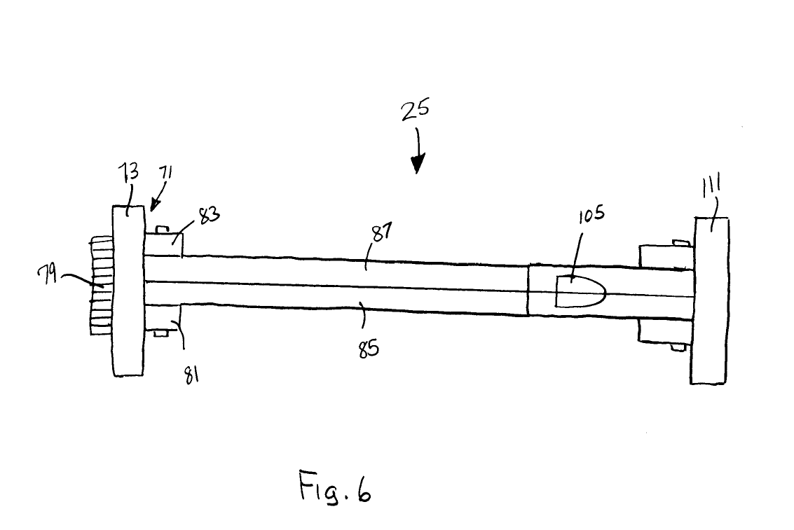

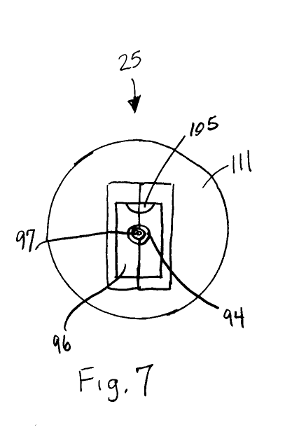

Nozzle assembly 25, which is also shown separately in FIGS. 6 and 7, may comprise a mounting bracket 71. Mounting bracket 71, which may be made of a suitably strong molded polymer, may comprise a base member 73 fixedly mounted within distal end 33 of first barrel portion 22-1. Base member 73 may be provided with a central opening (not shown). An array of flow tubes 79, which may be, for example, small diameter capillary tubes made of a suitably smooth polymeric material, such as a polycarbonate, may be coupled to the central opening of base member 73 and may extend proximally from base member 73 into first barrel portion 22-1, flow tubes 79 preferably being arranged along the longitudinal axis of first barrel portion 22-1 to promote laminar flow. Mounting bracket 71 may additionally comprise a pair of walls 81 and 83, which may be spaced apart from one another and which may extend distally a short distance from base member 73.

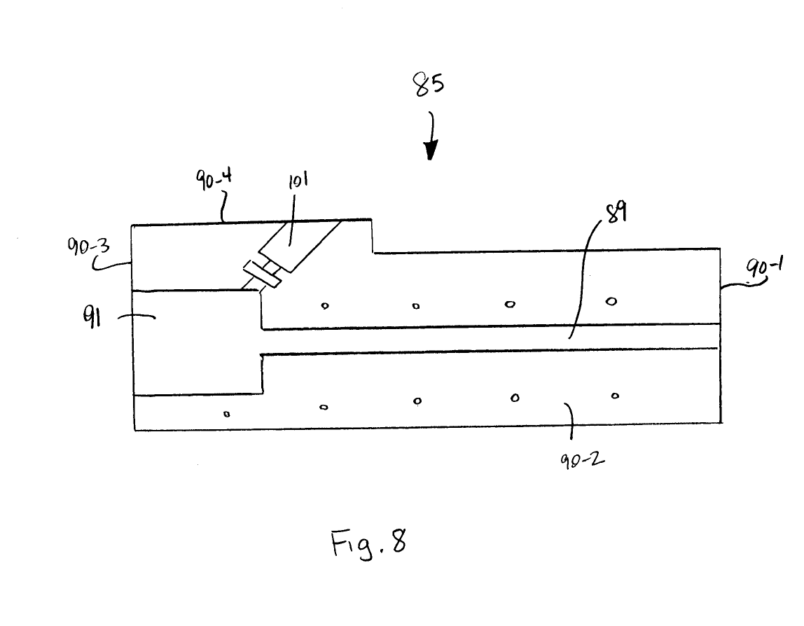

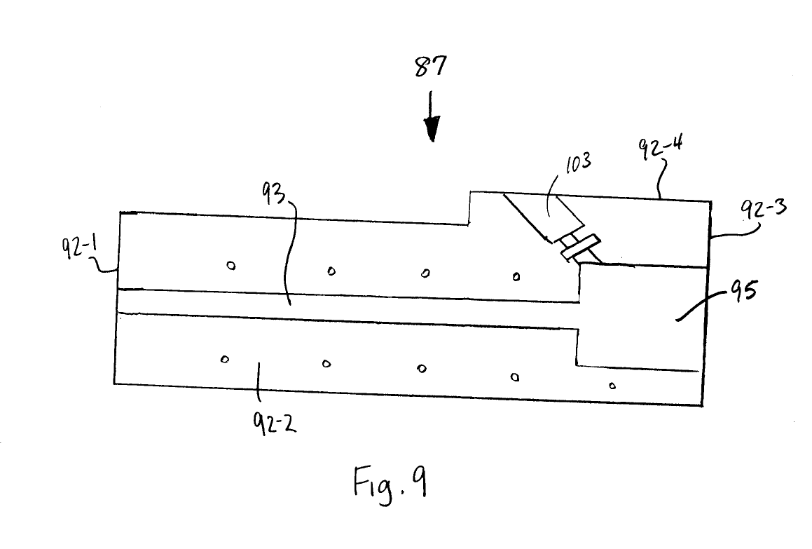

Nozzle assembly 25 may additionally comprise a pair of support members 85 and 87, which may be joined to one another by suitable means. Support members 85 and 87 may be positioned within walls 81 and 83, with support member 85 secured to wall 81 and support member 87 secured to wall 83. As seen best in FIG. 8, support member 85, which may be shaped to include a comparatively smaller semi-cylindrical groove 89 that extends distally from a proximal end 90-1 of support member 85 on an inner surface 90-2 thereof and a comparatively larger generally rectangular groove 91 that extends proximally from a distal end 90-3 of support member 85 on inner surface 90-2, grooves 89 and 91 being aligned with one another. As seen best in FIG. 9, support member 87 may be shaped to include a comparatively smaller semi-cylindrical groove 93 that extends distally from a proximal end 92-1 of support member 87 on an inner surface 92-2 thereof and a comparatively larger rectangular groove 95 that extends proximally from a distal end 92-3 of support member 87 on inner surface 92-2, grooves 93 and 95 being aligned with one another. As seen best in FIG. 7, groove 89 of support member 85 and groove 93 of support member 87 may cooperatively define a generally cylindrical channel 94, and groove 91 of support member 87 and groove 95 of support member 87 may cooperatively define a generally rectangular channel 96, generally cylindrical channel 94 and generally rectangular channel 96 being aligned with one another. As seen best in FIG. 7, dispensing tube 97, which may be, for example, a capillary tube made of a suitably smooth polymeric material, such as a polycarbonate, may have a length substantially equal to that of generally cylindrical channel 94 and may be matingly received within generally cylindrical channel 94 such that the distal end of dispensing tube 97 opens into generally rectangular channel 96. As can readily be appreciated, the length of the liquid stream generated by device 11 is attributable, at least in part, to the diameter of dispensing tube 97. Preferably, the diameter of dispensing tube 97 is selected so that a liquid stream of approximately 15-30 feet, as measured horizontally, may be generated. Such a stream may be generated, for example, using a dispensing tube having an inner diameter of approximately 0.75 mm to 1.5 mm, preferably about 1 mm.

As seen best in FIG. 8, support member 85 may additionally be shaped to include a groove 101, which may extend at a shallow angle from a top surface 90-4 of support member 85 to rectangular groove 91. Similarly, as seen best in FIG. 9, support member 87 may additionally be shaped to include a groove 103, which may extend at a shallow angle from a top surface 92-4 of support member 87 to rectangular groove 95. In this manner, grooves 101 and 103 may cooperatively define a channel 105 that may communicate with generally rectangular channel 96 at a shallow angle relative to the longitudinal axis of dispensing tube 97.

As seen best in FIGS. 6 and 7, nozzle assembly 25 may further comprise an annular end member 111 secured to the distal ends 90-3 and 92-3 of support members 85 and 87, respectively.

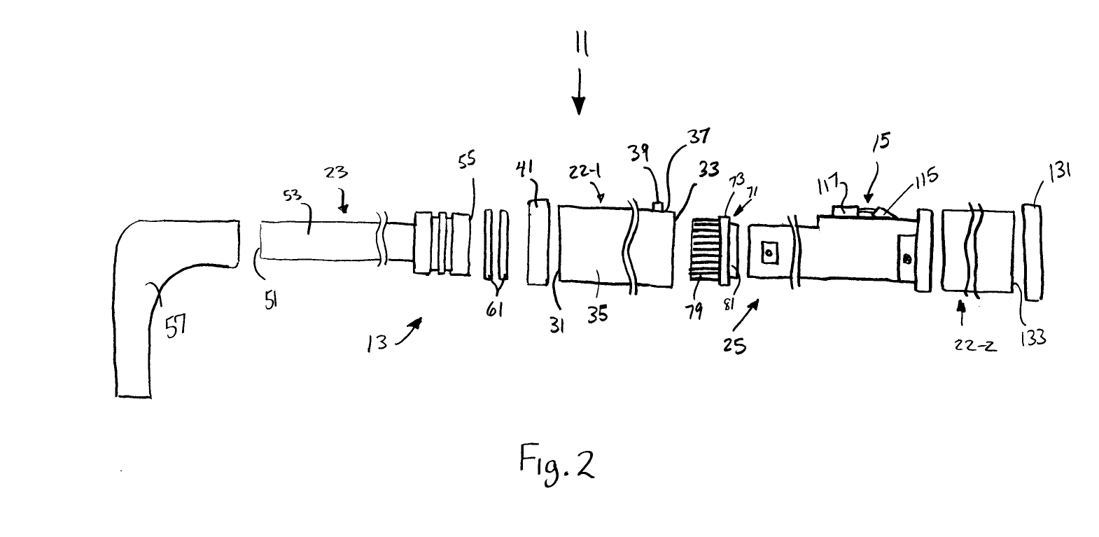

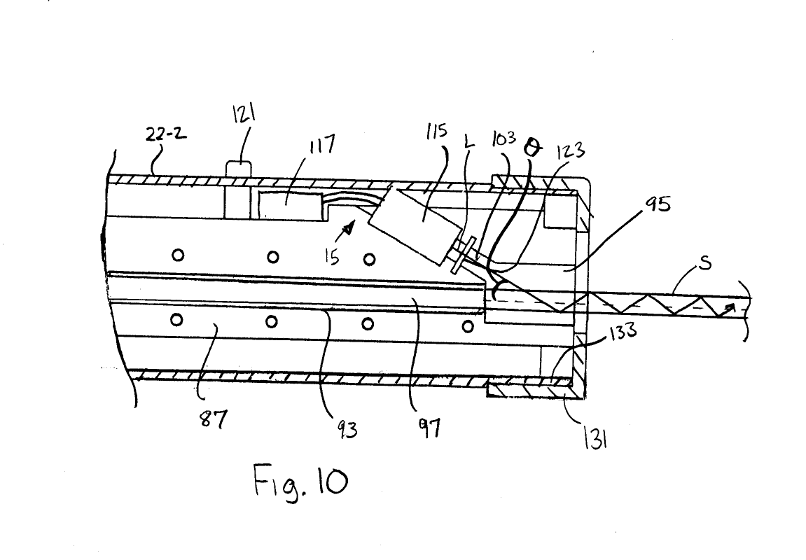

As seen best in FIGS. 2 through 4, illumination device 15 may comprise a light source 115, such as an LED, a laser, or other suitable illumination means, as well as a suitable power source 117, such as one or more dc batteries electrically coupled to light source 115. Light source 115 may be appropriately positioned within channel 105 so that light emitted from light source 115 may be directed at a liquid stream that has been emitted from capillary tube 97 and is moving distally through rectangular channel 96 in such a manner that the light strikes the liquid stream within rectangular channel 96 at an angle resulting in total internal reflection of the incident light. Preferably, as seen in FIG. 10, to effect total internal reflection, the light L emitted from light source 115 must be incident on the liquid stream S at an angle Θ, as measured relative to the longitudinal axis of the liquid stream S, wherein Θ is less than the critical angle that is needed for total internal reflection. Where the liquid is water or a predominantly water-based mixture, the aforementioned critical angle is about 42 degrees, and a preferred angle of incidence of the light, as measured relative to the longitudinal axis of the liquid stream, is about 30 degrees.

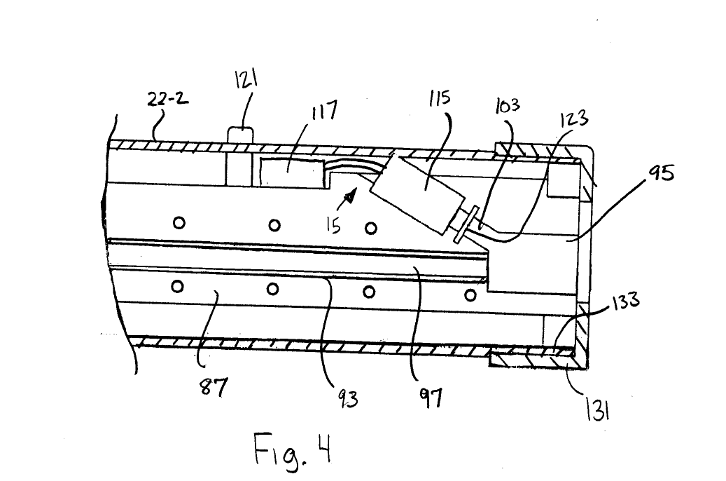

The light emitted from light source 115 may be monochromatic light but need not be and may be a continuous beam of light or light pulses. If the light emitted from illuminating device is in the form of light pulses, such light pulses may be of an appropriately duration so that device 11 has the effect of emitting glowing bullets or tracer fire. The operation of light source 115 may be controlled by a manually-operable switch 121, which may have, for example, one or more of on, off, and pulsed settings. A timed-out switch (not shown) may also be included to turn off the light source 115 after a predetermined period of inactivity of device 11. An optically transparent splash guard 123 (see FIG. 4) may be positioned between light source 115 and the liquid stream emitted from capillary tube 97 to minimize the likelihood that light source 115 may get wet during use.

An annular end cap 131 may be fixedly secured to a distal end 133 of second barrel portion 22-2.

In use, with plunger 23 in a distal position relative to barrel 21, valve 39 may be submerged in a liquid, such as water or a mixture of water and one or more additives, such as the additives identified above, and plunger 23 may then be moved to a proximal position relative to barrel 21, whereby the liquid may be drawn by suction into the interior of first barrel portion 22-1. Illumination device 15 may then be turned on, and with device 11 aimed at a desired target, plunger 23 may then be moved distally relative to barrel 21, whereby the water within first barrel portion 21 may be driven distally through nozzle assembly 25 and out the distal end of device 11, whereby such liquid may become illuminated by illumination device 15 through the principle of total internal reflection as such liquid passes through generally rectangular channel 96.

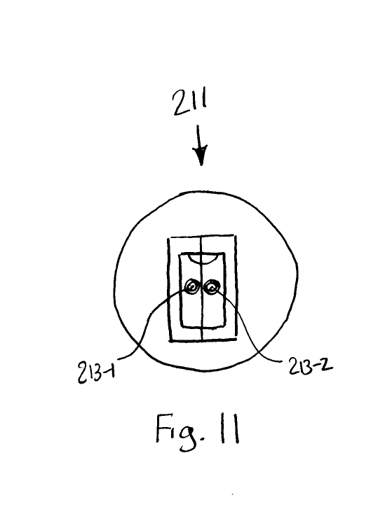

As can readily be appreciated, whereas device 11 may include a single dispensing tube 97, in another embodiment, the device may comprise a plurality of dispensing tubes. For example, referring now to FIG. 11, there is shown an alternative embodiment of a nozzle assembly represented generally by reference numeral 211. Nozzle assembly 211 differs principally from nozzle assembly 25 in that nozzle assembly 211 may comprise a plurality of dispensing tubes 213-1 and 213-2. It should be understood that, although two dispensing tubes are shown in nozzle assembly 211, there could be three or more such dispensing tubes. Alternative embodiments may include the use of a honeycomb-type of dispensing conduits. It should be understood that, when using two or more dispensing tubes, such dispensing tubes should be arranged relative to the illumination device 15 so that the liquid stream from each dispensing tube may be illuminated by illumination device 15 using the principle of total internal reflection. This may be achieved by arranging the dispensing tubes in a side-by-side arrangement so that the streams from the respective tubes are illuminated satisfactorily (i.e., without one stream shielding another stream) and/or by using a plurality of illumination devices arranged to illuminate the streams from one or more vantage points.

It should be understood that, whereas, in the embodiments discussed above, the one or more liquid streams have been illuminated after such streams have emerged from their respective dispensing tubes, such illumination could take place while the liquid is still traveling through the dispensing tubes. For example, the light source could be positioned proximal to the proximal end of the dispensing tube. Alternatively, the dispensing tube could include at least an arcuately shaped portion, with the light source being directed at the arcuately shaped portion.

In another embodiment (not shown), the light is injected into the one or more liquid streams by an optically clear prism or optically clear cylindrical rod.

It should also be understood that, whereas, in the embodiments discussed above, the liquid stream generator 13 is a portable water projecting device in the form of a “water cannon,” the liquid stream generator 13 could be in the form of a “water pistol” or other alternate structures.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A device for emitting an illuminated liquid stream, the device comprising:
(a) a liquid stream generator for emitting at least one continuous liquid stream; and
(b) an illumination device for emitting light;
(c) wherein the liquid stream generator and the illumination device are arranged relative to one another so that light emitted from the illumination device is directed into at least one of the at least one continuous liquid stream at an angle such that at least one of the at least one continuous liquid stream is illuminated under the principle of total internal reflection.

2. The device as claimed in claim 1 wherein the liquid stream generator comprises a barrel and wherein the illumination device is arranged relative to the liquid stream generator so that illumination of at least one of the at least one continuous liquid stream takes place within the barrel.

3. The device as claimed in claim 2 wherein the liquid stream generator further comprises a fluid conduit and wherein the illumination device is arranged relative to the liquid stream generator so that illumination of at least one of the at least one continuous liquid stream takes place after the at least one continuous liquid stream emerges from the fluid conduit.

4. The device as claimed in claim 1 wherein the liquid stream generator emits a single continuous liquid stream.

5. The device as claimed in claim 1 wherein the liquid stream generator emits a plurality of continuous liquid streams.

6. The device as claimed in claim 1 wherein the light emitted from the illumination device is pulsed light.

7. The device as claimed in claim 1 wherein the light emitted from the illumination device is a continuous beam of light.

8. The device as claimed in claim 1 wherein the illumination device comprises at least one LED.

9. The device as claimed in claim 1 wherein the illumination device comprises at least one laser diode.

10. The device as claimed in claim 1 wherein the liquid stream generator is capable of emitting at least one continuous liquid stream having a horizontal length of about 15-30 feet.

11. The device as claimed in claim 1 wherein the liquid stream generator is a portable water projecting device.

12. The combination of a device as claimed in claim 1 and a liquid supply used to make the at least one continuous liquid stream.

13. The combination as claimed in claim 12 wherein the liquid supply comprises water.

14. The combination as claimed in claim 13 wherein the liquid supply further comprises a viscosity thickener.

15. The combination as claimed in claim 13 wherein the liquid supply further comprises a light-diffusing agent.

16. The combination as claimed in claim 13 wherein the liquid supply further comprises a viscosity thickener and a light-diffusing agent.

17. A method of generating an illuminated liquid stream, said method comprising the steps of:
(a) generating a continuous liquid stream using a portable water projecting device; and
(b) illuminating the continuous liquid stream at an angle such that the continuous liquid stream is illuminated under the principle of total internal reflection.

18. The method as claimed in claim 17 wherein the continuous liquid stream comprises water.

19. The method as claimed in claim 18 wherein the continuous liquid stream further comprises at least one of a viscosity thickener and a light-diffusing agent.
